(19) United States
(12) Patent Application Publication
(10) Pub. No.: US 2009/0226589 A1
(43) Pub. Date: Sep. 10, 2009

(54) Manufacturing process of colorant vegetable extracts modified tannin extract

(76) Inventor: Eber Lopes Ferreira, Sao Paulo (BR)

Correspondence Address: CLARK & BRODY, 1090 VERMONT AVENUE, NW, SUITE 250, WASHINGTON, DC, 20005, US

(21) Appl. No.: 12/073,469

(22) Filed: Mar. 5, 2008

(51) Int. Cl. A23L 1/28; A23L 1/275

(52) U.S. Cl. 426/540

(57) ABSTRACT

“MANUFACTURING PROCESS OF COLORANT VEGETABLE EXTRACTS MODIFIED BY TANNIN EXTRACT”, forming water-soluble modified colorants, objecting becoming them more resistant and stables to act in applicable processes of dyeing and coloration of textile fibers, paper, leather, wood and cosmetics, as well as manufacturing of different dyes towards several uses.

It includes the following steps:

a) Production of natural colorants extracts of annatto, turmeric, chlorophyll, indigo plant and animal like cochineal.

b) Production of tannin extract of acacia mimosa.

c) Mixture of a natural colorant extract and a tannin extract, both in liquid form.

d) Homogenization and condensation of the obtained mixture.

e) Powder atomization of the mixture condensed in a Spray-dried equipment or any other equipment able to this purpose.

Obtained products:

1—Orange Nat-UR2: Powder Natural Colorant of Annatto (Bixa ollerana, Bixáceas) extract, mixed to a tannin extract of acacia mimosa (Acacia mearnsii), of general use and uniform quality. Composition: Norbixine: 0.1 to 50% and Tannin: 50 to 99.9%.

2—Yellow Nat-CM2: Powder Natural Colorant of Turmeric (Curcuma longa, Zingibereáceas) extract, mixed to a tannin extract of acacia mimosa (Acacia mearnsii), of general use and uniform quality. Composition: Turmeric: 0.1 to 50% and Tannin: 50 to 99.9%.

3—Green Nat-CL2—Powder Natural Colorant of Chlorophyll (Cuprocolofilina) extract, mixed to a tannin extract of acacia mimosa (Acacia mearnsii), of general use and uniform quality. Composition: Cuprocolofilina: 0.1 to 50% and Tannin: 50 to 99.9%.

4—Blue Nat-IND2—Powder Natural Colorant of Indigo plant (Indigofera tinctoria) extract, mixed to a tannin extract of acacia mimosa (Acacia mearnsii), of general use and uniform quality. Composition: Indigotine: 0.1 to 50% and Tannin: 50 to 99.9%.

5—Red Nat-CC2—Powder Natural Colorant of Cochineal (Coccus cacti) extract, mixed to a tannin extract of acacia mimosa (Acacia mearnsii), of general use and uniform quality. Composition: Carminic acid: 0.1 to 50% and Tannin: 50 to 99.9%.

The current invention patent “MANUFACTURING PROCESS OF COLORANT VEGETABLE EXTRACTS MODIFIED BY TANNIN EXTRACT” regards to a chemical process, resulting in more resistant and stable colorants.

The proposal technique consists on description of a process of industrial manufacturing of colorant of modified vegetable extracts through mixing them with a vegetable mordant, the tannin.

Thus, the colorant acquires more resistance and stability. This mixture is obtained by homogenization, condensation and dehydration of a natural colorant extract with a tannin extract of acacia mimosa.

This manufacturing process of water-soluble modified colorant vegetable extract has the objective of acting on applicable processes of dyeing and coloring of textile fibers, paper, leather, wood and cosmetics, as also on manufacturing of different dye to several uses.

### SHORT DESCRIPTION OF THE STATE OF THE ART

In seeking to reproduce the colors of the world, the human being has found in nature, among minerals, flora and fauna, the needed chromatic elements to ornament his body, utensils, adornments, weapons and houses. He transformed, so, elements from nature, in culture artifacts, impregining these objects with the essence of his soul expressed by colors.

Vegetable colorants are living organic substances, synthesized by plants through the root absorption of different nutrients and metals derived from various kind of soil. Metabolized by moon, sunlight and photosynthesis influence it varies during the day, according to the variation of light and air as well as during the year, according to the seasons. On his endless mutation process, its colors breathe and suffer soft changes on its tonality.

The upper plants absorb existing metals in the soil (copper, aluminum, magnesium, potassium, cobalt, chromium, iron and tin), catalyzing biochemical syntheses reactions, making possible the formations of colorants in several parts of the plants (seeds, flowers, leaves, roots, bark and stems). This color fixation process on the cellular structure of the plan is known by metallization (maturation), and, in the most cases, the stability of the colors only remains while the plant will be alive.

Natural colorants, composition and properties:

The natural colorants are found mainly among vegetables (upper plants, Algae, fungi and lichens). On the upper plants, the colorants can be found on the heartwood, sap, bark, roots, leaves, flowers, fruits and seed. It also can be found among certain animals (insects and shellfish). There are some insects, for example, the cochineal, the kermes and shellfish like squid and murex, that have chromatic material with a high power of fixation concentrated on its secretions.

These organic substances found in the metabolism of plants and animals are assorted from chromogenical groups that, by spectrophotometry, indicate a pattern of chromatic reading of its chemical composition. They are mostly denominated by organic chemistry as glycosides—compounds highly distributed on the vegetable that through hydrolysis, release one or more sugar molecules. Among all groups, we shall quote:

The natural colorants that present coloration of red spectrum (from pink to reddish-brown) are constituted by anthraquinone and/or dihydropyrenoid. Among the plants that have reddish colorants, we can quote the rubia (Rubia tictoria) which has as its colorant substance the alizarin and the Brazil wood (Caesealpinia equinata) with colorant substance the brasilina (coloring substance extracted from Brazil wood). In the midst of animal colorants, the cochineal (Coccus cacti) has as its colorant substance the carminic acid.

Amid the colorants of the spectrum orange and brown, constituted by carotenoid and/or the naphthoquinone, we can quote the annatto (Bixa orellana) that has as its colorant substance the norbixin, the reseda (Lawsonia inermis) that has as its colorant substance the henna, the walnut (Juglans regia) that has as its colorant substance the jug lone tannin, and the acacia mimosa (Acacia meamsii) that has as its colorant substance the fisetin tannin.

On the spectrum of the yellows, we can find colorants constituted by flavonoids among the plants of saffron-of-land (curcuma longa), with colorant substance the turmeric, the carnation (Tagetes sp) with colorant substance the luteoline. We also find some carotenoid on plants, like the true saffron (Crocus sativus) with colorant substance the crocetine and the taiúva—specimen of the Moraceae—(Maclura tinctoria), with colorant substance the morim or the maclurine.

On the spectrum of green color, the colorants are represented by chlorophylls presented on plants like garden parsley (Pretoselinum sativum) the spinach (Spinacea oleracea), the alfalfa (Medicago sativa), the urtica (Urtica dioica) and the mint (Menta piperita).

On the spectrum of the blue color, we can find the indigoids, present on the plants of anil (Indigofera tinctoria), indigo (Solanum indigoferum) and the anil plant (Isatis tinctoria), that has the indigotin as colorant substance.

On the spectrum of purple, the colorants are constituted by dihydropyrenoids, present on plants as campeachy wood (Haematoxylum campeachianum), that has as colorant substance the hematoxylin, and the genipap (Genipa Americana), as colorant substance the genipapine (haematein).

The natural colorants can be separately or combined used. A special feature of these colorants is the alteration of its coloration according to environmental pH or solution where it is diluted: many of them are used as indicators to measure the acidity and alkalinity of chemical solutions. Due to this feature, the natural colorants present vast versatility on its use and applications. The production of natural colorants in Brazil:

As is known, Brazil has very rich biodiversity where are found an expressive variety of native and introduced plants, rich on natural colorants. Many of them are cultivated and used on reforestation, which makes possible its exploration and the utilization for this purpose. There is an unexplored and expressive potential for extraction, production and use of natural colorants in the country, this is unknown and deserves bigger attention.

Adding to this, the deep knowledge of traditional Brazilian people about the production and using of natural colorant from native plants passed from father to son through generations. Many of these plants are cultivated, like the annatto (Bixa ollerana, Bixáceas), the saffron-of-land (Curmua longa, Zingibereáceas), the indigo (Indigofera tinctoria, Fabáceas), the spinach (Spinacea oleracea), the cabbage palm (Euterpe Oleracea).

These plants can be used for production of colorant extracts with several applications on food industry, cosmetics, leather, paper and textile. When associated to an industrial process of extraction, it becomes a new income source for small rural producers.

### SUMMARY OF THE OBJECT OF THE PATENT

The extracts of natural colorants are obtained by aqueous lixiviation of leaves, roots, branches, barks, flowers, fruits and seeds of native plants, cultivated and/or reforested. It also can be extracted from lichens, fungus and seaweeds as much as some animals, like cochineals and squids. The extraction is done in stainless equipment, or copper or tempered glass, or even aluminium, with a temperature of 60° to 120° C. (Celsius degrees). The extraction occurs in a closed system type self heating to steam and pressure, or open to ebullition, and also in an extractor type Soxhlet with coupling condenser, or any other industrial equipment able to realize the extraction. On this equipment, is done the entrainment through the circulation of the shower or the steam, extracting the colorant and making it solvable in water.

It has the objective to act on coloration and dyeing processes of textile fibers, leather, paper, wood and cosmetics, as also on fabrication of dye to different purposes, such as water-soluble and/or hydro missive extracts due to the interest of the companies in adjustment to environmental standards, which takes them to look for sources of color that cause less environmental impact and are able to substitute the chemical aniline that attacks the environment and affects the health of its employees and consumers.

Thus, the invention consists of the following processes:

a) These extracts are obtained by lixiviation of native plants, cultivated and/or reforested when triturating parts of the plant to be used for extraction with more efficiency. In stainless equipment, or any other plastic material, we put the triturated raw material to soak in cleaning water, to ambient temperature, where are added an alcohol or an alkali, or any other solvent that can be used for this purpose. The alcohol used can be from cereals, methanol, ethanol, isopropanol, butanol, cyclobutanol, pentanol or a mixture in any proportion of these, on concentration of 0.01 to 50 g/liter of solution. As alkali, can be used sodium hydroxide, potassium hydroxide, lithium hydroxide, calcium hydroxide, magnesium hydroxide, beryllium hydroxide, ammonium hydroxide or ammonia, sodium carbonate (Na2CO3), or potassium hydroxide (KOH) or a water of ash (lye) on concentration of 0.01 to 20 g/l. of the solution, or any other solvent used for this purpose.

b) To let the mixture homogeny it has to be agitated and so is done the extraction by lixiviation or entrainment under pressure in stainless equipment, or copper or tempered glass, or aluminum, from 60° to 120° C. temperature. The extraction occurs in a steam and pressure self heating closed system, or open to ebullition, and also in an extractor type Soxhlet with a coupling condenser, or any other industrial equipment able for this extraction. On this equipment, is done the entrainment through shower or steam circulation, extracting the colorant and making it solvable in water. On this way, is obtained the natural colorants and the extract of tannin of acacia mimosa.

c) The next step is to mix the extract of natural colorant with the extract of tannin of acacia mimosa, both in liquid form, in a stainless equipment, or any other material in proportion that can vary from 0.01 to 5% of extract of natural colorant and 50 to 99.99% of extract of tannin on ambient temperature, when this mixture suffers an addition of the temperature until 80° C. to make possible its homogenization.

d) Then, is made the homogenization and the condensation by agitation in a stainless recipient, or any other material, using a condenser, or any other equipment, with the objective of reducing the quantity of water from the resulting extract.

e) So, it is dehydrated by powder atomization of the mixture in equipment type Spray-dried, or any other industrial equipment able to this purpose.

Process of extraction of colorant from cultivable plants:

### EXAMPLE 1

Natural colorant of annatto (11330)—Kuhn, H. Helv. Chim. Acta 12, 904 (1929).

The natural extract of annatto is produced by extraction of existing colorant on pellicle of annatto (Bixa ollerana, Bixáceas) seeds. The main colorant element is bixine or norbixine, but at least six other colorants are also present, among them the carotene. As direct colorant to wool, silk and cotton, is obtained a yellowish-orange colorant on the presence of alum of potassium, aluminum acetate, aluminum sulphate and a reddish-orange on the presence of copper, copper sulphate, copper acetate; on the presence of rust, iron acetate, iron sulphate, and/or ferrous sulphate it presents a yellowish-brown colorant. It becomes yellowish-green on the presence of chromium salts and lemon yellow on the presence of chromium salts and lemon yellow on the presence of tin salts. The textile fiber pursues a good tinctorial affinity.

### Extraction Process:

Since the immersion of annatto seeds on water solution, alcohol and an alkali, or any other solvent able to be used for this purpose, the extraction is done. The alcohol used can be from cereals, methanol, ethanol, isopropanol, butanol, cyclobutanol, pentanol, or a mixture of theses in any proportion in a concentration from 0.01 to 50 g/l of the solution. As alkali, can be used sodium hydroxide, lithium hydroxide, calcium hydroxide, magnesium hydroxide, beryllium hydroxide, ammonium hydroxide or ammonia, sodium carbonate (Na2CO3), or potassium hydroxide (KOH), or other soft alkali with water of ash (lye) on the concentration from 0.01 to 20 g/liter of the solution. In stainless equipment, or copper, or tempered glass, or aluminium, or any other material, submitted to a temperature from 60° to 120° C. The extraction occurs in a steam and pressure self heating closed system, or open to the ebullition and also in an extractor type Soxhlet with coupling condenser or any other industrial equipment able to make this extraction where is done the entrainment through the circulation of the shower or the steam. The obtained product is a dense liquid with an orange-brown coloration or a reddish-orange paste rich in carotenoid. Depending on its application, is realized the standardization of its concentration. The extract obtained has good solvability in hot water and when it is used in dyeing of textile fibers the result is a good penetration, good power of colorant and excellent efficiency.
Norbixine, demineralized water, alcohol and alkali.
Chemical name: mono metil ester acid, carotenoid
Chemical formula: C25H3004
Molecular weight: 394.49
When isolated, the substance presents a reddish-orange paste.
Solvable in alcohol, water, chloroform and acetone.
Reactions of color in the presence of:
H2SO4 acquires a blue coloration, if diluted, it becomes dark-blue.
Typical Analysis
Physical Aspect: liquid in a tonality orange-brown.
Ionic feature: anionic
pH: 5.5-8.0
Color: from yellowish-orange to orange-red

### EXAMPLE 2

Turmeric natural colorant (I 2681)
Vogel, Ann, 44, 294 (1842)
Perkin, P., J. Chem. Soc. (Trans) 85, I, 64 (1904)
Rao, S., J. Chem. Ind. 47, 54T (1928)
Stieglitz, H. Ger pat 859145 (1952 Hoechst)

The turmeric natural extract emulsified in water is produced since root of saffron (long turmeric, Zingibereáceas) and has as its colorant element the turmeric yellow of the chromogenical group of carotenoid that, due to its oil feature, needs to be emulsion in aqueous solution. It presents a greenish-yellow coloration or orange-yellow in the presence of potassium alum, aluminium acetate and aluminium sulphate; almost black coloration in the presence of iron sulphate, rust and iron acetate: reddish-orange in the presence of copper sulphate, copper acetate and stannous chloride; dark-brown in the presence of chromo salts. It pursues a good tinctorial affinity with textile fibers.

As a direct colorant, it is applied alone, with tannin and/or with a small quantity of alum potassium, iron sulphate, copper sulphate, iron acetate, copper acetate, ferrous sulphate, acetic acid or an acid salt, or sodium sulphate, aluminium sulphate, sodium chloride and marine salt.

### Extraction Process:

From the fresh and triturated root saffron-of-earth is done the extraction in aqueous solution with addition of alcohol and an alkali, or any other solvable able to this purpose. The alcohol used can be from cereals, methanol, ethanol, isopropanol, butanol, cyclobutanol, pentanol, or a mixture of these in any proportion on the concentration from 0.01 to 50 g/liter of solution. As alkali, can be utilized sodium hydroxide, lithium hydroxide, calcium hydroxide, magnesium hydroxide, beryllium hydroxide, ammonium hydroxide or ammonia, sodium carbonate (Na2CO3) or potassium hydroxide (KOH) or any other soft alkali as water of ash (lye) on the concentration from 0.01 to 20 g/liter of the solution. In stainless equipment, or copper or tempered glass, or aluminium or any other material submitted to a 60° to 120° C. temperature. The extraction occurs in a closed self-heating system or any other industrial equipment able for this extraction, by steam or direct heat. The resulting extract is a yellowish-brown dense liquid. After the standardization of its concentration and evaporation of the alcohol and the alkali in a open system of ebullition, is done an emulsion with an emulsifier like a water solvable soap or a neutral protein, or gelatin, or a polysorbate 80, or any emulsifier that do not change the nature of the colorant substance.

The turmeric extract, when in contact with the alkali, acquires an orange-red coloration and, when in contact with acids, acquires a greenish-yellow and bright yellow coloration.

The emulsified extract present good solvability in hot water and, when used on a dyeing of textile fiber, it presents good penetration, good power of coloration and excellent efficiency.

### Composition:

Curcumin, demineralized water and emulsifier.
Chemical name: diferuloylmethane, flavonoid
Chemical formula: C21H2006
Molecular Weight: 368.37
When isolated, the substance is presented as a yellowish-orange crystal. Insolvable in water and ether. Solvable in alcohol and glacial acetic acid. It acquires the orange-red coloration when in the presence of alkalis and bright-yellow in the presence of acids.
Color reactions in presence of:
H2SO4 reddish-brown fiber and solution; if diluted, the fiber becomes drought and pale and the solution does not present coloration.
HCl reddish-brown fiber; solution in soft pink; if diluted, the fiber becomes soft-yellow.
HNO3 deep red, changing to yellow.
NaOH bright reddish orange fiber and solution.

### Typical Analysis

Physical Aspect: yellowish-brown paste liquid.
Ionic feature: anionic
pH: 2.5-8.0
Color: yellowish-brown

### EXAMPLE 3

### Chlorophyll Natural Colorant

The natural extract of the green pigment of chlorophyll is obtained from several plants like garden parsley (Petroselinum sativum), the spinach (Spinacea oleracea), the lucern (Medicago sativa), the urtica (urica dioica) and the mint-mentha (menta piperita), and it is necessary a chemical modification to make it stable. When stabilized, in the presence of potassium alum, aluminium sulphate and aluminum acetate, it presents intense green coloration: in the presence of iron sulphate, rust, ferrous sulphate and iron acetate it becomes moss green: in the presence of copper, copper sulphate, copper acetate, it tone of green becomes lighter. It presents a good tinctorial affinity in textile fiber of vegetable and animal origin. It also can be used to color food and cosmetics, to prepare of dye, dyeing leather and act as accelerator in the vulcanization of rubber.

From fresh leaves of plants like garden parsley (Petroselinum sativum), the spinach (Spinacea oleracea), the lucern (Medicago sativa), the urtica (urica dioica) and the mint-mentha (mentha piperita), is done the extraction in aqueous solution with addition of alcohol and an alkali, or any other solvable able to this purpose. The alcohol used can be from cereals, methanol, ethanol, isopropanol, butanol, cyclobutanol, pentanol, or a mixture of these in any proportion on the concentration from 0.01 to 50 g/liter of solution. As alkali, can be utilized sodium hydroxide, lithium hydroxide, calcium hydroxide, magnesium hydroxide, beryllium hydroxide, ammonium hydroxide or ammonia, sodium carbonate (Na2CO3) or potassium hydroxide (KOH) or any other soft alkali as water of ash (lye) on the concentration from 0.01 to 20 giliter of the solution.

The extraction occurs in a steam and pressure self-heating closed system, or open to the ebullition and also in an extractor type Soxhlet with coupling condenser or any other industrial equipment able to make this extraction where is done the entrainment through the circulation of the shower, heated by steam or direct heat. During the process is realized a acid hydrolysis utilizing formic acid, acetic acid or any soft acid in the presence of copper metal or copper acetate to cause the substitution of the magnesium atom of the chlorophyll molecule into copper, forming, so, a stable pigmenticolorant named copper chlorophyllin. The obtained extract is a dark green dense liquid.

After the ebullition and neutralization of alkali through the boiling, in an open system, is done the standardization of its concentration.

The obtained extract presents good solvability in hot water and when it is used in dyeing of textile fibers it presents good penetration, good power of coloration and excellent efficiency.

### Composition:

Copper chlorophyllin, demineralized water and alcohol.
Chemical name: Copper chlorophyllin, chlorophyll.
Chemical Formula: C55H72CuN405
Molecular Weight: 935.28
When isolated, the substance presents like a bluish-green powder. It is solvable in water, alcohol and organic solvable.

### Typical Analysis:

Physical Aspect: intense green liquid
Ionic character: anionic
pH: 5.5-8.0
Color: light-green and bluish-green.

### EXAMPLE 4

Anil natural colorant (I 4827)
Volander. S., Ber. 34, 1860 (1901)
Metthews, Color Trade J. 6, 96 (1920)

The anil natural extract can be obtained from fermentation of several leaves of anil indigo plant (Indigofera tinctorial), big anil plant (Solanum indigoferum) and the indigo (Isatis tinctorial). It is found in Brazil in several plants of Indigofera sp from leguminous family and of Solanum sp from Solacenaceas family. From these plants is extracted a blue vegetable colorant, of chromo group of indigo, named indigotine, which is obtained from fermentation of its leaves. It pursues an excellent tinctorial affinity on textile fibers. Its light and washing resistance is good.

### Extraction Process

### Production of Stone Indigo:

Its production is unlike from other colorants: the extraction is done by ambient temperature between 25° and 45° C., in recipients that do not suffer oxidization like plastic, bricklaying, stainless. The process has to be done in a ventilated and covered site, in order to avoid interference on the fermentation.

The fresh leaves of anil indigo plant (Indigofera tinctoria), big anil plant (Solanum indigoferum) and the indigo (Isatis tinctorial) are immersed in clean water. The fermentation is caused by adding diluted urea or animal urine or sugar cane or it happens spontaneously. Three days after, is realized the leaves triturating immersed on shower. The fermentation is interrupted with the withdrawal of the branches and by alkalization of the shower. With the alkali, can be used hydrated lime, sodium hydroxide, potassium hydroxide, lithium hydroxide, calcium hydroxide, beryllium hydroxide, ammonium hydroxide and/or water of ash of carbonized vegetables—lye or any other solvable that can be used of this purpose.

To provoke the colorant precipitation is realized the process of oxygenation by agitation of the shower and addition of clean and cold water −5° to 15° C. After on day of rest, the floating liquid is extracted by sifonation and the precipitated is purified and dehydrated, is dried in tablets.

Production of Liquid Extract from Stone Indigo

The stone indigo, unsolvable in water, is triturated and diluted in water with alkali, ph 10 to 11. For shower alkalization , can be used hydrated lime, sodium hydroxide, potassium hydroxide, lithium hydroxide, calcium hydroxide, magnesium hydroxide, beryllium hydroxide, ammonium hydroxide and or water of ash of carbonized vegetables—lye or any other solvable that can be used of this purpose. Adding a reducing chemical agent such as sodium hydrosulphite, or sodium tilsulphite in quantities varying from 0.1 to 100 g/liter of the solution, for example. This reducer makes possible the colorant solvability and its use in dyeing process.

### Composition

Indigotine, reducing agent and alkali
The extract obtained is nearly solvable in water, alcohol and organic solvable, and it can solvable in an aqueous alkaline way and reducer.
Chemical name: Indigotine, glicosideo indigbide.
Chemical Formula: C16H10N202
Molecular Weight: 262.26
When isolated, the substance presents as a dark blue powder. Unsolvable in water, alcohol and organic solvable. It is solvable in an aqueous alkaline way and reducer.

### Typical Analysis

Physical Aspect: dark greenish blue liquid
Ionic character: Cationic
pH: 10.0-11.0
Color: dark greenish blue
Extraction Process of animal origin colorant

### EXAMPLE 5

Cochineal natural colorant (I 1844)
Schunk, M., Ber. 27, 2979 (1894)
Dimroth, S., Ber. 53, 471 (1920)

The cochineal natural colorant is produced from the existing substance in the dry body of the female cochineal insect (Coccus cacti, Homóptera). Its main colorant element is the carminic acid, of chromo group of anthraquinone. As colorant, is obtained several tonalities varying from pink to scarlet red. On the presence of potassium alum, aluminium sulphate, aluminium acetate it becomes carmesin, on the presence of tin salts it becomes scarlet, on the presence of chromo salt, it becomes purple, on the presence of copper, copper sulphate, copper acetate it becomes Bordeaux, on the presence of iron, rust and iron salts like iron sulphate, iron acetate and ferrous sulphate it becomes violet. It pursues a good tinctorial affinity to animal origin fiber and little affinity to vegetable origin fiber.

The dry female cochineal insect are immersed on water, alcohol and alkali solution, or nay other solvable that can be used for this purpose, under ambient temperature. The alcohol can be from cereals, methanol, ethanol, isopropanol, butanol, cyclobutanol, pentanol, or a mixture of these in any proportion on the concentration from 0.01 to 50 g/liter of the solution. As alkali, can be utilized sodium hydroxide, lithium hydroxide, calcium hydroxide, magnesium hydroxide, beryllium hydroxide, ammonium hydroxide or ammonia, sodium carbonate (Na2CO3) or potassium hydroxide (KOH) or any other soft alkali as water of ash (lye) on the concentration from 0.01 to 20 g/liter of the solution.

After a 2 to 8 hours period, is realized the extraction in stainless equipment, or copper, or tempered glass, or aluminium or any other material submitted to a 60° to 120° C. temperature. The extraction occurs in a closed self-heating system or any other industrial equipment able for this extraction, by steam or direct heat. The resulting extract is a scarlet red dense liquid. Increasing the temperature in an open circuit, and keeping it on 90° C. in a period from 5 to 30 minutes is realized the evaporation of part of the alcohol and the alkali. After this stage is done the standardization of the concentration on the liquid extract between 0.1% to 80% of colorant active material in the solution. The obtained extract presents good solvability in water, alcohol and concentrated sulfuric acid. Unsolvable in ether, benzene and chloroform.

### Composition

Carminic acid, demineralized water, alcohol and alkali.
Chemical name: carminic acid, anthraquinone
Chemical Formula: C22H20013
Molecular Weight: 492.38
When isolated, the substance presents as a scarlet red paste, water, alcohol and concentrated sulfuric acid solvable. Unsolvable in ether, benzene and chloroform.

### Color Reactions on the Presence of:

| | | |
|---|---|---|
| Reagent | Alum (mordant) | Tin (mordant) |
| H2SO4 | Scarlet | Dark violet |
| HCl | Scarlet | Orange red |
| HNO3 | Yellow | Yellow |
| SnCl2 | Orange red | Orange |
| NaOH | Purple | Purple |

### Typical Analysis

Physical Aspect: scarlet ret liquid.
Ionic character: Anionic
pH: 3.5-8.0
Color: pink to scarlet red

### Mordants

In order to make the natural colorants stables and permanents is used substances named mordant, which can be from vegetable, mineral, artificial and natural origin.

### Vegetable Origin Mordant

### Tannin

The vegetable mordant more commonly use are those rich in tannin, such as guava plant leaves, banana plant umbilicus, barbatimao, acacia, yam and angico that are utilized during or after dyeing shower.

The tannin word is used to designate two different groups of chemical substances of phenolic character: hydro tannin and condensed tannin. The vegetable extracts rich in condensed tannin can be obtained from several plants such us Acacia, Schinopsis, Tsuga, Rhus and several kinds of Pinus. The structure of condensed tannin extracts (flavonoid units with various levels of condensation) generally is represented by its precursors (flavan-3-ois and falvan-3,4-dióis), other similar flavonoid, carbohydrates, imino traces and aminoacids. When treated with strong and treaty-hot, it starts a progressive polymerisation process until total polymerisation originating amorphous tannins, known as flobafenes.

The water-soluble or pyrogallic tannins are molecular structures of polyesters, which contain a central skeleton of sugars like glucose connected to carboxylic phenol acids. The connection esters are formed by group interaction between alcoholics —OH and molecules with carboxylic grouping —COOH, of carboxylic phenol acids. It is easily hydrolysable by the action of strong acids, or enzymes. The results of this hydrolysis are sugars, alcohols and phenol carboxylic acid. The phenol carboxylic acid will dissociate in gallic acid and ellagic. The extract of chestnut tree are typical examples of hydrolysable or pyrogallic tannins.

An important feature of hydrolysable or pyrogallic extract of tannins is its natural acidity. These extracts normally have a pH between 2.8 and 3.6. The acidity is due to the presence of acids groups in the molecule of the tannin and free organic natural acid. The hydrolysable type tannins are obtained from chestnut tree, Tara, Myrabolan, Valonea, Divi Divi, Sumac, among others.

These tannins present variable coloration, depending on its oxidation, from terracotta from dark brown.

### EXAMPLE 6

### Vegetable Extract of Acacia Mimosa Tannin

The natural extract of Acacia Mimosa é produced from the extraction of the existing tannin of the tree barks of Acacia mimosa, Acacia Mearnsii, leguminous. The main colorant and mordant element is the tannin from de carotenoid group. As direct colorant to wool, silk and cotton, is achieved a light brown on the presence of potassium alum, aluminium acetate, copper sulphate or copper acetate: on the presence of rust, iron acetate, iron sulphate and/or ferrous sulphate it presents an orange brown. It becomes almost black on the presence of chrome salts; on the presence of tin salts it becomes reddish-brown. It pursues good tinctorial affinity with textile fibers.

### Extraction Process

From de immersion of triturated barks of Acacia in water, alcohol or alkali solution, or any other solvable that can be used for this purpose, is done the extraction. The alcohol used can be from cereals, methanol, ethanol, isopropanol, butanol, cyclobutanol, pentanol, or a mixture of theses in any proportion in a concentration from 0.01 to 50 g/liter of the solution. As alkali, can be utilized sodium hydroxide, lithium hydroxide, calcium hydroxide, magnesium hydroxide, beryllium hydroxide, ammonium hydroxide or ammonia, sodium carbonate (Na2CO3) or potassium hydroxide (KOH) or any other soft alkali as water of ash (lye) on the concentration from 0.01 to 20 g/liter of the solution. In stainless equipment, or copper, or tempered glass, or aluminium, or any other material, submitted to a temperature from 60° to 120° C.

The extraction occurs in a steam and pressure closed self-heating system, or open to the ebullition and also in an extractor type Soxhlet with coupling condenser or any other industrial equipment able to make this extraction where is done the entrainment through the circulation of the shower or the steam. The obtained product is a dense liquid with a dark brown coloration rich in carotenoid. Depending on its application, is realized standardization of its concentration. The extract obtained has good solvability in hot water and when it is used in dyeing of textile fibers the result is a good penetration, good power of colorant and excellent efficiency.

### Composition

Tannin and demineralized water.
Chemical name: phenol carboxylic acid, ester, carotenoid
Chemical Formula: C25H3004
Molecular Weight: 394.49
When isolated, the substance is presented as a reddish-brown powder. Water, chloroform and acetone solvable.

### Color Reactions on the Presence of:

NaOH acquires a blue coloration; if diluted, it becomes light blue.

### Typical Analysis

Physical Aspect: reddish-brown powder.
Ionic Character: Anionic pH: 3.5-6.0
Color: from terracotta salmon to dark brown.
Obtained products from mix of natural colorants extracts with Acacia Mimosa tannin extract:

### Product 1: Orange Nat-UR2

### Annatto and Tannin Natural Colorant

Orange Nat-UR2 is a powder natural extract from the mixture of annatto (Bixa ollerana, Bixáceas) extract and Acacia Mimosa tannin extract (Acacia mearnsii) of general use and uniform quality. It is characterized by a orange brown coloration, and it is indicated to give color to different raw materials and to be used in dyeing process of textile fibers in general, through associating a colorant and a mordant substance. It presents a good tinctorial affinity in vegetable origin fibers and a regular tinctorial affinity in animal origin fibers.

### 1) Composition

Norbixine: 0.1 to 50%
Tannin: 50 to 99.99%

### 2) Typical Analysis

Physical Aspect: hygroscopic orange brown powder
Ionic character: Anionic
Humidity: 4.5-6.5%
pH: 5.0-6.0
Color: yellowish-brown to orange brown

### 3) Properties

Orange Nat-UR2 presents easy solvability in hot water and pursues the following features in dyeing process:

Good penetration

Good fixation power

Excellent efficiency

### 4) Application

Orange Nat-UR2 cab be applied alone or combined with other vegetable extracts. It is recommended to be applied of (considering weight of dry textile fiber):

0.1 to 10% of Orange Nat-UR2 for light colors

6 to 30% of Nat-UR2 for dark colors.

### 5) Recommendations

During dyeing process, it can appear iron contamination risks, stain formation and variableness on pieces dyeing. In order to prevent these inconvenient, it is suggested the preparation of the dyeing material with metal sequestering agents, equalizing and a pre-showering with a neutral and peroxide detergent.

### 6) Stocks

Orange Nat-UR2 powder maintain its properties unchanged when stocked in a dry place, aired and protected from sunlight and packed in packaging properly closed.

### 7) Presentation

Orange Nat-UR2 can be packed on fibercan packaging of 1 to 5 kilos, as well as plastic bags of 25 kilos.

### Product 2: Yellow Nat-CM2

### Turmeric and Tannin Natural Colorant

Yellow Nat-CM2 is a powder natural extract produced from the mixture of turmeric (Curcuma longa, Zingibereáceas) extract and Acacia Mimosa (Acacia mearnsii) tannin extract, of general use and uniform quality. It is featured by an ochre yellow coloration and it is indicated for giving color to different raw material on dyeing process of textile fibers in general due to associate a colorant substance to a mordant. It presents a good tinctorial affinity on vegetable and animal origin fibers.

### 1) Composition

Turmeric: 0.1 to 50%
Tannin: 50 to 99.9%

### 2) Typical Analysis

Physical aspect: ochre yellow hygroscope powder
Ionic character: Anionic
Humidity: 4.5-6.5%
pH: 5.0-6.0%
Color: ochre yellow

### 3) Properties

Yellow Nat-CM2 presents higher solvability on hot water and it pursues the following features on dyeing process:

Good penetration

Good power of fixation but low durability if exposed to light

Excellent efficiency
Yellow Nat-CM2 can be applied alone or combined with other vegetable extracts. It is recommended the application of (considering weight of dry textile fiber):

0.1 to 6% of Yellow Nat-CM2 for light colors

6 to 30% of Yellow Nat-CM2 for dark colors

### 5) Recommendations

During dyeing process, it can appear iron contamination risks, stain formation and variableness on dyeing of pieces. In order to prevent these inconvenient, it is proposed the preparation of the dyeing material with metal sequestering agents, equalizing and a pre-showering with a neutral detergent and peroxide.

### 6) Stocks

Yellow Nat-CM2 powder maintains its properties unchanged when stocked in a dry place, aired and protected from sunlight and packed in packaging properly closed.

### 7) Presentation

Yellow Nat-CM2 can be packed on fibercan packaging of 1 to 5 kilos, as well as in 25 kilos plastic bags.

### Product 3: Green Nat-CL2

### Cuprochlorophyllin and Tannin Natural Extract

Green Nat-CL2 is a powder natural extract produced from de mixture of chlorophyll extract and Acacia Mimosa (Acacia mearnsii) tannin extract, of general use and uniform quality. It is featured by green coloration and it is indicated to give color to different raw materials and on dyeing process of textile fibers in general due to association of a colorant substance and a mordant. It presents good tinctorial affinity on vegetable origin fibers and a regular tinctorial affinity on animal origin fibers.

### 1) Composition

Cuprochlorophyllin: 0.1 to 50%
Tannin: 50 to 99.9%

### 2) Typical Analysis

Physical aspect: green hygroscope powder
Ionic character: Anionic
Humidity: 4.5-6.5%
pH: 5.0-6.0%
Color: green

### 3) Properties

Green Nat-CL2 presents higher solvability on hot water and it pursues the following features on dyeing process:

Good penetration

Good power of fixation

Excellent efficiency

### 4) Application

Green Nat-CL2 can be applied alone or combined with other vegetable extracts. It is recommended the application of (considering weight of dry textile fiber):

0.1 to 6% of Green Nat-CL2 for light colors

6 to 30% of Green Nat-CL2 for dark colors

### 5) Recommendations

During dyeing process, it can appear iron contamination risks, stain formation and variableness on dyeing of pieces. In order to prevent these inconvenient, it is proposed the preparation of the dyeing material with metal sequestering agents, equalizing and a pre-showering with a neutral detergent and peroxide.

### 6) Stocks

Green Nat-CL2 powder maintains its properties unchanged when stocked in a dry place, aired and protected from sunlight and packed in packaging properly closed.

### 7) Presentation

Green Nat-CL2 can be packed on fibercan packaging of 1 to 5 kilos, as well as in 25 kilos plastic bags.

### Product 4: Blue Nat-IND2

### Indigo and Tannin Natural Colorant

Blue Nat-IND2 is a powder natural extract produced from de mixture of Indigo (Indigofera tinctoria) extract and Acacia Mimosa (Acacia mearnsii) tannin extract, of general use and uniform quality. It is featured by bluish gray coloration and it is indicated to give color to different raw materials and on dyeing process of textile fibers in general due to association of a colorant substance and a mordant. It presents good tinctorial affinity on vegetable and animal origin fibers.

### 1) Composition

Indigotin: 0.1 to 50%
Tannin: 50 to 99.9%

### 4) Typical Analysis

Physical aspect: bluish gray hygroscope powder
Ionic character: Anionic
Humidity: 4.5-6.5%
pH: 8.0-10
Color: bluish green and bluish gray

### 5) Properties

Blue Nat-IND2 presents higher solvability on warm water (40° C.) and it pursues the following features on dyeing process:

Good penetration

Good power of fixation

Excellent efficiency

### 4) Application

Blue Nat-IND2 can be applied alone or combined with other vegetable extracts. It is recommended the application of (considering weight of dry textile fiber):

0.1 to 10% of Blue Nat-IND2 for light colors

10 to 30% of Blue Nat-IND2 for dark colors

### 5) Recommendations

During dyeing process, it can appear iron contamination risks, stain formation and variableness on dyeing of pieces. In order to prevent these inconvenient, it is proposed the preparation of the dyeing material with metal sequestering agents, equalizing and a pre-showering with a neutral detergent and peroxide.

### 6) Stocks

Blue Nat-IND2 powder maintains its properties unchanged when stocked in a dry place, aired and protected from sunlight and packed in packaging properly closed.

### 7) Presentation

Blue Nat-IND2 can be packed on fibercan packaging of 1 to 5 kilos, as well as in 25 kilos plastic bags.

### Product 5: Red Nat-CC2

### Cochineal and Tannin Natural Colorant

Red Nat-CC2 is a powder natural extract produced from de mixture of Cochineal (Coccus cacti) extract and Acacia Mimosa (Acacia mearnsii) tannin extract, of general use and uniform quality. It is featured by reddish-pink coloration and it is indicated to give color to different raw materials and on dyeing process of textile fibers in general due to association of a colorant substance and a mordant. It presents good tinctorial affinity on vegetable and animal origin fibers.

### 1) Composition

Carminic acid: 0.1 to 50%
Tannin: 50 to 99.9%

### 2) Typical Analysis

Physical aspect: reddish pink hygroscope powder
Ionic character: Anionic
Humidity: 4.5-6.5%
pH: 5.0-6.0
Color: reddish pink

### 3) Properties

Red Nat-CC2 presents higher solvability on warm water (40° C.) and it pursues the following features on dyeing process:

Good penetration

Good power of fixation

Excellent efficiency

### 4) Application

Red Nat-CC2 can be applied alone or combined with other vegetable extracts. It is recommended the application of (considering weight of dry textile fiber):

0.1 to 10% of Red Nat-CC2 for light colors

10 to 30% of Red Nat-CC2 for dark colors

### 5) Recommendations

During dyeing process, it can appear iron contamination risks, stain formation and variableness on dyeing of pieces. In order to prevent these inconvenient, it is proposed the preparation of the dyeing material with metal sequestering agents, equalizing and a pre-showering with a neutral detergent and peroxide.

### 6) Stocks

Red Nat-CC2 powder maintains its properties unchanged when stocked in a dry place, aired and protected from sunlight and packed in packaging properly closed.

### 7) Presentation

Red Nat-CC2 can be packed on fibercan packaging of 1 to 5 kilos, as well as in 25 kilos plastic bags.

1) “MANUFACTURING PROCESS OF COLORANT VEGETABLE EXTRACTS MODIFIED BY TANNIN EXTRACT”, featured by industrial changing of extracts from vegetable colorants mixed with a vegetable mordant, the tannin, by homogenization, condensation and dehydration, of a extract of natural colorant with a extract of acacia mimosa tannin. The manufacturing process includes several phases, such as: a) production of extracts from vegetable colorants of annatto, turmeric, spinach, anil plant and animals like cochineal as described on 1 to 5 examples of the above text of the referring patent. The extracts of natural colorants are obtained by aqueous lixiviation of leaves, roots, barks, branches, flowers, fruits and seeds of native, cultivated and/or reforested plants, in stainless equipment, or of copper, or tempered glass, or aluminium, or any other material, submitted to a temperature from 60° to 120° C. The extraction occurs in a closed self heating system, to steam and pressure, or open to the ebullition and also in an extractor type Soxhlet with coupling condenser or any other industrial equipment able for this extraction. On this equipment, is done the entrainment through the circulation of the shower or the steam extracting the colorant and making it water solvable; b) production of extract of acacia mimosa tannin; c) Mixing the extract of natural colorant with the extract of acacia mimosa tannin, both in liquid shape, in stainless equipment or any other material, on the proportion from 0.01 to 50% of extract of natural colorant and 50 to 99.99% of extract of tannin in ambient temperature, when this mixture suffers and addition of heat till 80° C. to make possible its homogenization; d) the homogenization and condensation is done through agitation of the mixture in stainless equipment or any other material, using a condenser objecting the reduction of the quantity of water on the resulting extracting; e) the dehydration is achieved by powder atomization of the condensed mixture in a Spray-dried equipment or any other equipment able to this purpose.

2) “MANUFACTURING PROCESS OF COLORANT VEGETABLE EXTRACTS MODIFIED BY TANNIN EXTRACT”, according to claim 1, featured by the fact that the obtained products from the mixture of natural colorants with the extract of acacia mimosa tannin are: 1—Orange Nat-UR2—Natural Colorant of Annatto and powder tannin, produced by the mixture of annatto (Bixa ollerana, Bixáceas) extract and extract of acacia mimosa (Acacia mearnsii) tannin, composition: Norbixine, 0.1 to 50% and Tannin 50 to 99.9%; 2—Yellow Nat-CM2—Natural Colorant of Turmeric and powder tannin, produced by the mixture of turmeric (Curcuma longa, Zingibereaceas) extract and tannin extract of acacia mimosa (Acacia mearnsii). Composition: Turmeri 0.1 to 50% and Tannin 50 to 99.9%; 3—Green Nat-CL2—Natural Colorant of Cuprochlorophyllin and powder tannin, produced from the mixture of chlorophyll extract and tannin extract of acacia mimosa (Acacia mearnsii), composition: Cuprochlorophyllin 0.1 to 50% and Tannin 50 to 99.9%; 4—Blue Nat-IND4—Natural Colorant of Indigo Plant and powder tannin, produced from the mixture of indigo (Indigofera tinctoria) plant extract and tannin extract of acacia mimosa (Acacia mearnsii), composition: Indigotine 0.1 to 50% and Tannin 50 to 99.9%; 5—Red Nat-CC2—Natural Colorant of Cochineal and powder Tannin, produced by the mixture of cochineal (Coccus cacti) extract with tannin extract of acacia mimosa (Acacia mearnsii), composition: carminic acid 0.1 to 50% and Tannin 50 to 99.9%.
